(19) United States
(12) Patent Application Publication
(10) Pub. No.: US 2014/0058581 A1
(43) Pub. Date: Feb. 27, 2014

(54) DYNAMIC AUTONOMOUS SYSTEM PERFORMANCE PREDICTION METHODOLOGY

(71) Applicant: DRS Sustainment Systems, Inc., St. Louis, MO (US)

(72) Inventors: Travis Dierks, Wentzville, MO (US); Matthew Wootton, O'Fallon, MO (US)

(73) Assignee: DRS Sustainment Systems, Inc., St. Louis, MO (US)

(21) Appl. No.: 13/974,480

(22) Filed: Aug. 23, 2013

Related U.S. Application Data
(60) Provisional application No. 61/693,586, filed on Aug. 27, 2012.

(51) Int. Cl. B60W 50/00

(52) U.S. Cl. CPC B60W 50/00
USPC 701/1

(57) ABSTRACT

Methods and apparatuses are presented for optimizing performance of a base vehicle platform (e.g. an automobile) and operating the base vehicle platform without human intervention. Some embodiments may receive base vehicle platform data indicative of at least one performance characteristic of the base vehicle platform. Some embodiments may also receive environmental conditions data indicative of at least one characteristic of at least one weather condition or terrain condition, and receive base sensor data from at least one base sensor indicative of at least one up-to-date environmental condition or base vehicle platform condition. Embodiments may then generate at least one module based on the base vehicle platform data, the environmental conditions data, and the base sensor data, such that the at least one module operates the base vehicle platform without human intervention, and dynamically modifies at least one base vehicle platform performance characteristic without human reconfiguration.

### CROSS REFERENCE TO RELATED APPLICATIONS

This application claims the benefit of U.S. Provisional Patent Application No. 61/693,586, filed Aug. 27, 2012, and titled “DYNAMIC AUTONOMOUS SYSTEM PERFORMANCE PREDICTION METHODOLOGY,” the disclosure of which is hereby incorporated herein in its entirety and for all purposes.

### BACKGROUND

A goal of robotics and automated technologies may be to automate processes and devices that may normally require a human to operate. Increasingly, more devices, machines, and vehicles have been created to automate behaviors or tasks that normally require at least some actions performed by humans. For example, a luxury automobile may automatically redistribute an amount of torque between the front and rear wheels of the vehicle, depending on what road conditions are identified (e.g. slippery, sandy, normal conditions, etc.), rather than have a driver downshift gears or manually push buttons to change torque distributions. While researchers may focus on a single device or machine to try to automate, the systems created tend to not be reconfigurable for any other type of device or machine other than the device or machine it was originally intended for. In other words, general systems controllers configured to operate multiple types of devices or machines may not often be a focus in robotics and automated technologies. It may be desirable then to generate a system controller with more general capabilities configured to operate multiple types of machines.

### BRIEF SUMMARY

Embodiments of the invention may solve these aforementioned problems and other problems according to the disclosures provided herein.

Methods and apparatuses are presented for optimizing performance of a base vehicle platform (e.g. an automobile) and operating the base vehicle platform without human intervention. The base vehicle platform may be an input to embodiments, allowing a single embodiment to optimize performance of multiple base vehicle platforms without manual or human reconfiguration. Some embodiments may receive base vehicle platform data indicative of at least one performance characteristic of the base vehicle platform. Some embodiments may also receive environmental conditions data indicative of at least one characteristic of at least one weather condition or terrain condition, and receive base sensor data from at least one base sensor indicative of at least one up-to-date environmental condition or base vehicle platform condition. Some embodiments may also receive at least one user input as initial constraints on embodiments. Embodiments may then generate at least one module based on the base vehicle platform data, the environmental conditions data, the at least one user input, and the base sensor data, such that the at least one module operates the base vehicle platform without human intervention, where the module dynamically modifies at least one base vehicle platform performance characteristic of the base vehicle platform without human reconfiguration.

Some embodiments may generate a Sensor Performance module based on the base sensor data and the environmental conditions data, such that the Sensor Performance module determines at least one performance characteristic of the at least one base sensor for at least one environmental condition. Embodiments may also generate a Base Vehicle Platform Performance module based on the base vehicle platform data and the environmental conditions data, such that the Base Vehicle Platform Performance module determines at least one optimal performance condition of the base vehicle platform as a function of at least one weather condition or terrain feature.

Some embodiments may generate a System Performance Predicting Algorithm module configured to determine at least one constraint specifying what elements are needed in order to achieve a predetermined level of system performance of the base vehicle platform. Embodiments may also generate a Dynamically Bounded System Controller module configured to change at least one maximum performance characteristic of the base vehicle platform without human intervention and/or operate the base vehicle platform without human intervention.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a vehicle driving in a weather condition.

FIG. 2 illustrates a different vehicle employing some embodiments.

FIG. 3A is a functional flowchart according to some embodiments.

FIG. 3B is a functional flowchart according to some embodiments.

FIG. 4 is a detailed functional flowchart according to some embodiments.

FIG. 5A is a graph showing some performance characteristics used in some embodiments.

FIG. 5B is a graph showing some performance characteristics used in some embodiments.

FIG. 6 is an example computer system according to some embodiments.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The term “base vehicle platform” may refer to any vehicle configured to move within an environment. A base vehicle platform may have performance characteristics (e.g. properties describing how well the base vehicle platform maneuvers, handles, etc.) that may be expressed quantitatively. Accordingly, the term “base vehicle platform data” may refer to data in a human and/or machine readable format describing at least one performance characteristic of the base vehicle platform. Some descriptions herein may refer to a base vehicle platform and base vehicle platform data interchangeably.

The term “base sensor” or “base sensors” may refer to at least one sensor located on or around the base vehicle platform, each base sensor configured to detect a condition on or around the base vehicle platform. Accordingly, the term “base sensor data” may refer to data derived from the at least one base sensor representing information about what is detected by the at least one base sensor. Some descriptions herein may refer to base sensors and base sensor data interchangeably.

The term “environmental conditions” may refer to at least one condition describing the surrounding environment of a base vehicle platform, e.g. rain, snow, sleet, rocky terrain, ice, trees, sand, wind, etc. Accordingly, the term “environmental conditions data” may refer to data in a human and/or machine readable format representing at least one environmental condition. Some descriptions herein may refer to environmental conditions and environmental conditions data interchangeably.

Apparatuses and methods are presented for automatically and dynamically optimizing performance parameters of a base vehicle platform (e.g. an automobile), based on at least one performance characteristic. For example, embodiments may incorporate the performance characteristics of the base vehicle platform, attached peripherals such as sensors, initial human-defined constraints, and measurements of external environmental conditions, such that the base vehicle platform may operate at its performance limits without the need for human reconfiguration.

Computer systems may have been developed for modifying the performance of some vehicles, like luxury cars or remote-controlled aircraft, based on knowledge of performance constraints of that particular vehicle and environmental sensors that provide data on present environmental conditions around that vehicle. However, these systems may be built to cater to a specific vehicle or class of vehicles, may not reconfigurable to adapt to any other type of vehicle, and may have constraints that are manually calibrated. For example, while a luxury car from one manufacturer may be able to adjust its handling performance during heavy rain, the system as designed is not reconfigurable to modify performance of a luxury car from a different manufacturer, and the system may have been manually calibrated, e.g. continually tested and recalibrated by researchers in a performance lab.

According to some embodiments, however, a methodology is presented for optimizing the performance of a base vehicle platform that includes as one variable the base vehicle platform itself. Embodiments may therefore be reconfigurable to adapt to any type of vehicle by accepting a different base vehicle platform as an input. Furthermore, user inputs are provided only as initial performance constraints. Thereafter, no human testing or recalibration may be required.

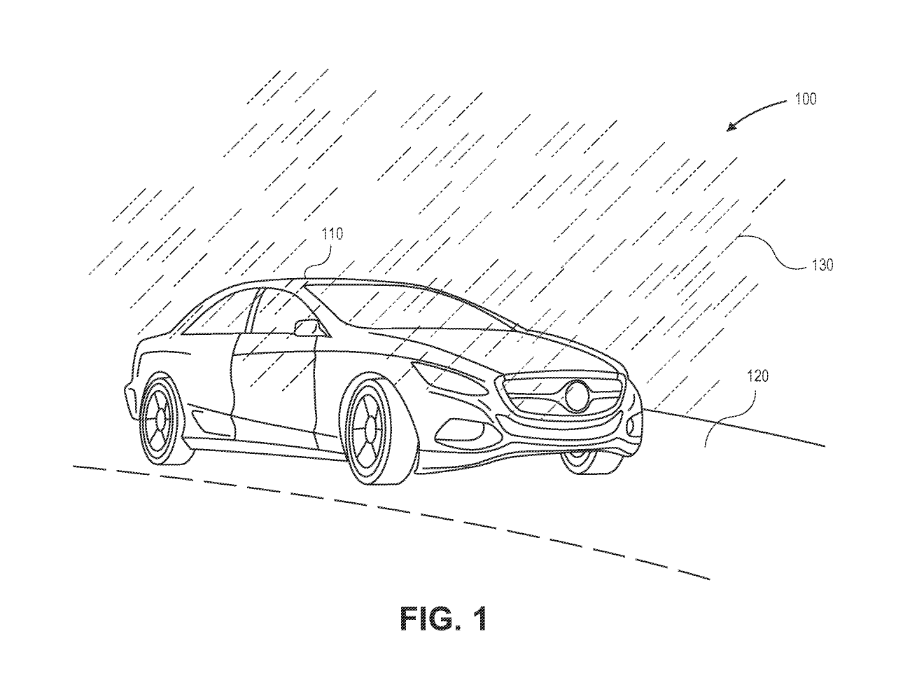

Referring to FIG. 1, illustration 100 may show a vehicle 110 driving in a weather condition 130. Vehicle 110 may be equipped with sensors to detect that it is raining 130, and may subsequently adjust its performance to be better suited to drive on road 120. A number of luxury vehicles currently in the market may have the ability to adjust the performance of the vehicle depending on changing weather conditions. For example, in rain, the luxury vehicle may first sense precipitation on the vehicle and then may expand the tires farther out from the vehicle to offer better stability. In other cases, the driver of vehicle 110 may know that it is raining, and then reconfigure vehicle 110 to adjust the tires for better stability by pushing a switch or button that changes some feature of the vehicle. Other examples of changing performance may include adjusting to 4-wheel drive instead of 2-wheel drive, enabling more powerful headlights, or adjusting the acceleration capabilities of the vehicle 110.

Vehicle 110 may respond to other types of weather or environmental conditions not shown. For example, in snow, vehicle 110 may be configured to perform similar types of adjustments. The driver may manually push buttons or switches enabling such features. Vehicle 110 may also have sensors that may detect such environmental conditions, subsequently enabling vehicle 110 to use such functionality described, either automatically or upon the driver's command.

The system designed to perform such functionality as described for this particular luxury vehicle 110 may be specially configured for just that vehicle type, where a manufacturer of a different vehicle brand may implement a different system. Additionally, vehicle 110 may have been manually calibrated and tested in a factory or testing lab in order to calibrate the performance characteristics as described.

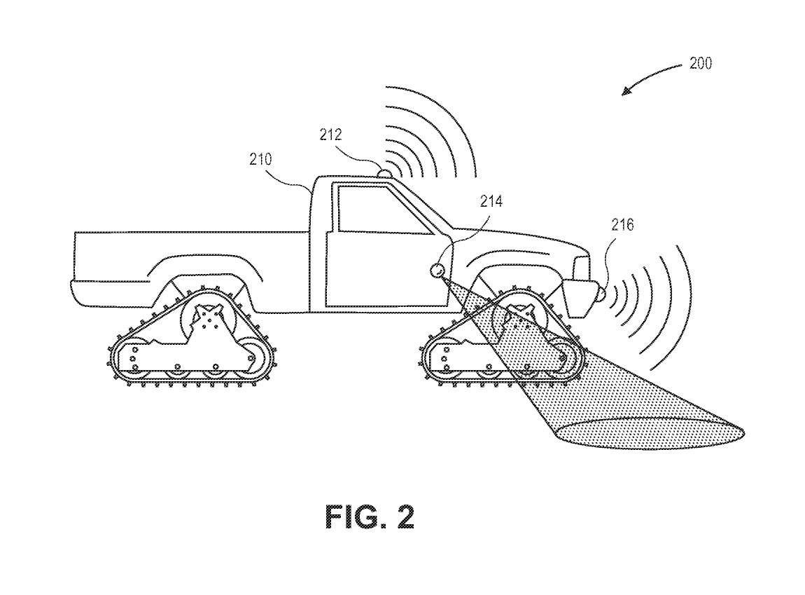

Referring to FIG. 2, illustration 200 may show a different vehicle 210 also capable of adjusting its performance depending on environmental conditions. In this case, vehicle 210 may be equipped with sensors 212, 214, and 216 for detecting environmental conditions similar to those described in FIG. 1, but also others including, for example, heavy wind, large ditches, roadblocks, rocks and other obstacles. Sensors 212, 214, and 216 may be different types of sensors, including light detection and ranging (LIDAR), radio detection and ranging (RADAR), sound detection and ranging (SONAR), thermometers, weight sensors, cameras, night-vision sensors, inertial sensors, and the like. Other examples known in the art are also possible.

A commercial system for adjusting performance used in vehicle 110 may not be configured to operate successfully in vehicle 210. This may be because the commercial system of vehicle 110 may be configured only for that particular vehicle, or that particular vehicle type. Vehicle 210 may be built by a different manufacturer, or vehicle 210 may be different class of vehicles altogether (e.g. an all-terrain vehicle, a half-track transport, a tank, etc.).

However, embodiments of the present invention may be configured to enhance the performances of both vehicle 110 and vehicle 210 using the same embodiment. Whereas commercial systems for adjusting performance of a vehicle may take only environmental conditions as inputs, some embodiments may take the vehicle itself, referred to herein as a base vehicle platform, as a separate input. Vehicle 110 and vehicle 210 may be viewed as different types of base vehicle platforms, because vehicle 110 may have physical and performance characteristics that differ from vehicle 210 (e.g. different weight, aero dynamics, body shape, handling, etc.). By using embodiments presented herein, a single system may be configured to enhance the performance of multiple base vehicle platforms, including those described in FIGS. 1 and 2.

Additionally, commercial systems for adjusting performance of a vehicle may rely on a driver or other human adjustments conducted in real time. Embodiments of the present invention, however, may be able to enhance the performance of base vehicle platforms in real time without human intervention. Embodiments may design a dynamically bounded system controller configurable to operate a base vehicle platform, detect and respond to environmental and other conditions, and maneuver the base vehicle platform without human intervention.

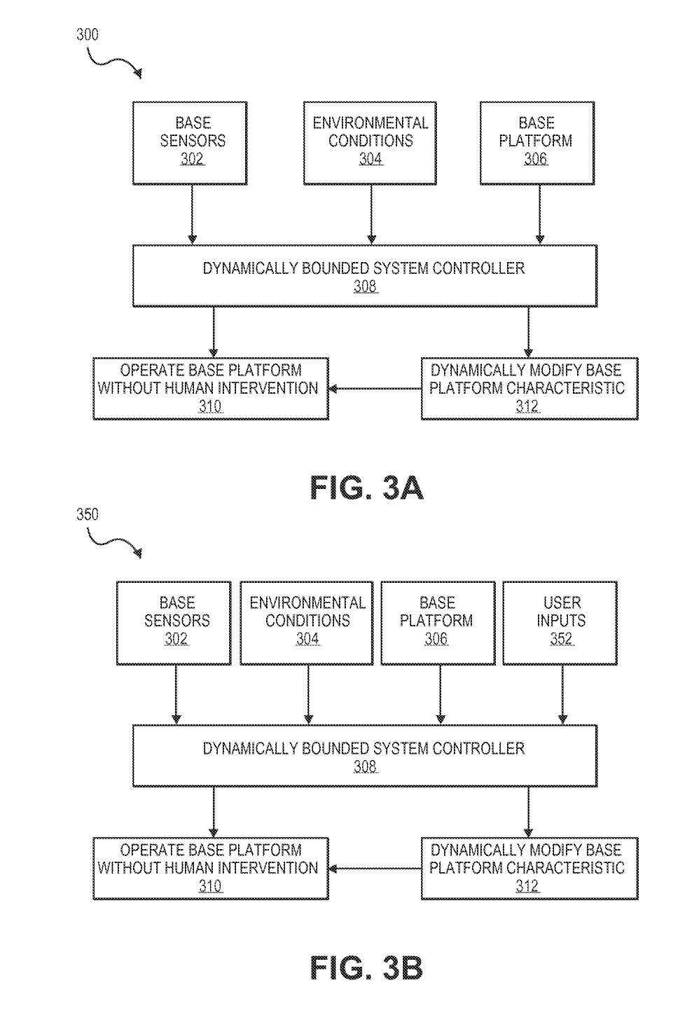

Referring to FIG. 3A, flowchart 300 may illustrate a functional diagram of some embodiments. Embodiments may take as inputs data from base sensors 302, data of environmental conditions 304, and data of a base vehicle platform 306. For example, a base vehicle platform 306 could be a Segway, a Black-I robotic Landshark, or even an Ml Abrams tank. Included in this block 306 may also be knowledge of the vehicle's base performance characteristics, such as mobility capabilities—e.g. turning radius, braking capabilities, top speed, wheel type, rolling resistance etc. A base vehicle platform may be described in terms of various characteristics, including its mass, center of mass, inertia, ground contact location and type, motion constraints (e.g., skid-steer, akermin, holonomic, etc.), suspension performance, acceleration/deceleration capabilities including turning characteristics, and others apparent to those with ordinary skill in the art. A base vehicle platform may include a full-design schematic, which may help relate each of the parameters previously described with each of the other parameters and other elements to be combined in order to create a performance envelope, e.g. a set of constraints describing maximum performance across various performance metrics. This performance envelope may be described as a function or series of functions based on all such inputs which describes the potential performance envelopes of the platform. For example, a parameterized set of differential equations may be used to relate the specific vehicle parameters and performance metrics to a predicted motion model.

The base sensors 302 may be various sensors attached to the base vehicle platform 306 and configured to provide data indicative of up-to-date environmental and base vehicle conditions. Examples may include RADAR, inertial sensors, and laser sensors. Environmental conditions 304 may be any weather condition, such as wind or rain, but may also include terrain features like rough terrain surfaces or rocky obstacle conditions.

Embodiments may incorporate these three inputs 302, 304, and 306, to create a dynamically bounded system controller 308. The system controller 308 may be configured to operate the base vehicle platform 306 using data about the base vehicle platform, the data provided about and by the base sensors 302, in response to data about the environmental conditions detected 304. At block 310, with knowledge of the environmental conditions 304 and knowledge of the performance characteristics of base vehicle platform 306, the system controller 308 can operate without human intervention in real time. In other words, a driver of the base vehicle platform 306 would not be required, for example.

Additionally, at block 312, the system controller 308 may dynamically modify at least one base vehicle platform characteristic in real time. That is, the system controller 308 may change the way the base vehicle platform operates in response to changing environmental conditions. For example, the system controller 308 may reduce the maximum speed of the base vehicle platform 306 when receiving data from base sensors 302 that the environmental conditions 304 have changed from sunny weather to heavy rainy weather. Nor for example would there need to be an operator to push switches or activate functionality in response to changing environmental conditions, in contrast to some of the operations described in FIG. 1. Thus, the system controller may operate block 312 without human intervention, leading back to block 310.

Referring to FIG. 3B, embodiments may also incorporate initial user inputs 352 as an additional input to generating system controller 308. User inputs 352 may be human-defined constraints independent of environmental conditions. Examples may be a predefined maximum speed of the base vehicle platform, or absolute or conditioned instructions, such as “always avoid holes greater than a certain size” or “reduce max speed during night time.” Other examples may include safety constraints that take into account performance more suitable for passengers and bystanders. User inputs 352 may artificially limit the range in performance of some embodiments according to the user's requirements. User inputs 352 may be inputted, for example, so that a base vehicle platform may properly obey a speed limit while operating without human intervention. The other blocks in FIG. 3B may be consistent with those already described in FIG. 3A, except with the additional constraints provided by block 352.

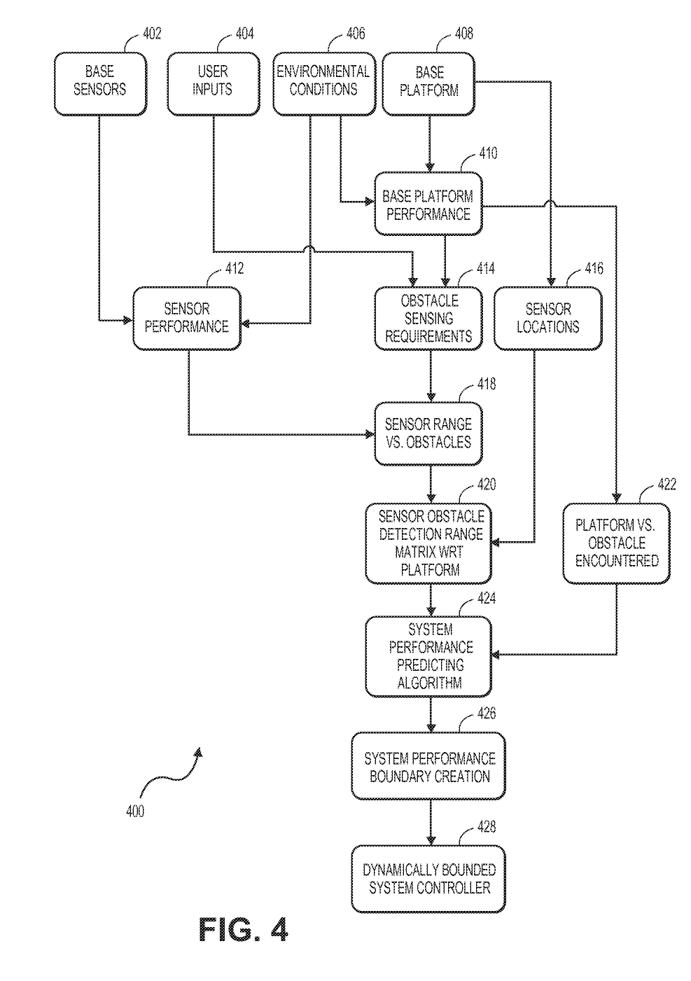

Referring to FIG. 4, block flow diagram 400 may represent a more specific functional implementation according to some embodiments. Similar to embodiments described in FIGS. 3A and 3B, the blocks at the top of diagram 400 may represent four possible inputs into systems of various embodiments: base sensors 402, user inputs 404, environmental conditions 406 and a base platform 408, which may also be referred to as a base vehicle platform for clarity. Examples of each type of blocks 402, 404, 406 and 408 may be consistent with those already described in FIGS. 3A and 3B.

Embodiments may then generate an automated system that dynamically configures the base vehicle platform 408 to perform at its operational limits, based on all of the aforementioned four types of data inputs. Referring still to FIG. 4, the remaining blocks 410-428 may represent various types of computations, calculations, functions, matrices, modules, or subsystems that serve as further inputs to more complex calculations, subsystems, or modules. Embodiments may generate each module 410-428 as separate software programs. In other embodiments, a single software program may be generated to implement all of the modules. Some embodiments may include all of the modules 410-428, while others may include only some or just one, with subsequently varying degrees of functionality available. The arrows may indicate what inputs may be used to generate a following subsystem block. Each module 410-428 may also access look-up tables, databases, and/or matrices of information that may be experimentally derived or mathematically modeled.

Still referring to FIG. 4, a Base Platform Performance module or subsystem 410 may be generated by computing how the known base vehicle platform performance characteristics 408 interact with environmental conditions 406. The Base Platform Performance module 410 may describe what may be the maximum performance conditions of the base vehicle platform 408 as a function of weather condition and terrain feature. For example, max speed of an all-terrain vehicle may be described in a two-dimensional chart that lists the max speed while in dry conditions, rainy conditions, windy conditions, etc, crossed with smooth surfaces, rough surfaces, sandy surfaces, etc. Each mobility characteristic of the base vehicle platform 408 may be similarly described as a function of environmental conditions 406. Some embodiments may use a multi-dimensional chart, interrelating differing weather conditions (e.g. rain, snow, etc.) crossed with differing terrain conditions (e.g. road, sand, etc.) to generate a set of maximum velocities for each weather/terrain scenario. Some embodiments may also include an additional dimension of a probability of achieving said maximum velocities. Determining such probabilities may be based on the known base vehicle platform characteristics and knowledge of how the weather and terrain conditions may affect the base vehicle platform.

How well the base vehicle platform 408 performs to overcome obstacles can also therefore be computed using the known base platform performance characteristics 408, and may be expressed as data in the Platform vs. Obstacles Encountered module 422. Data here may be expressed as probabilities, e.g. how likely the base vehicle platform 408 is to traverse a gap 8 inches wide for a given speed. For example, for each environmental condition based on data from module 406, now that embodiments may know how fast the base vehicle platform 408 may travel, how fast it can turn, how quickly it can stop, etc., embodiments may determine how likely it is that the base vehicle platform 408 can travel over a large rock 10 inches tall, drive through the side of a wooden barn, or drive across a trench with a 2 foot-wide opening. Module 422 may compute and describe these relationships.

An Obstacle Sensing Requirements module 414 may be generated by combining the user inputs specifications 404 with the Base Platform Performance module 410. Based on the specifications of the user 404, and factoring in the computed performance of the base vehicle platform 410 for each type of weather and terrain condition, embodiments may compute at module 414 what are the requirements of the base sensors such that the base vehicle platform 408 can have sufficient data to account for environmental and obstacle conditions in order to perform optimally. For example, one obstacle base sensor requirement may be the requirement that the sensors must be able to detect for holes deeper than 25 centimeters. This may be based on a calculation by module 414 that, based on the user's inputs 404 and the performance capabilities of the base vehicle platform according to module 410, that sensors unable to detect for holes deeper than 25 centimeters may likely cause the base vehicle platform 408 to fall into a hole of that size or greater which it may not be able to get out of.

Similar to Base Platform Performance module 410, Sensor Performance module 412 may be generated in order to determine performance characteristics of each base sensor 402 for each environmental condition 406, e.g. a given weather or terrain condition. For example, it may be determined that a laser sensor is severely affected by snow and thus has a lower maximum detection range than normal, but is unaffected by wind and thus the maximum detection range does not change. Each sensor's performance may be determined for each type of environmental condition and calculated, contained, and/or displayed in module 412.

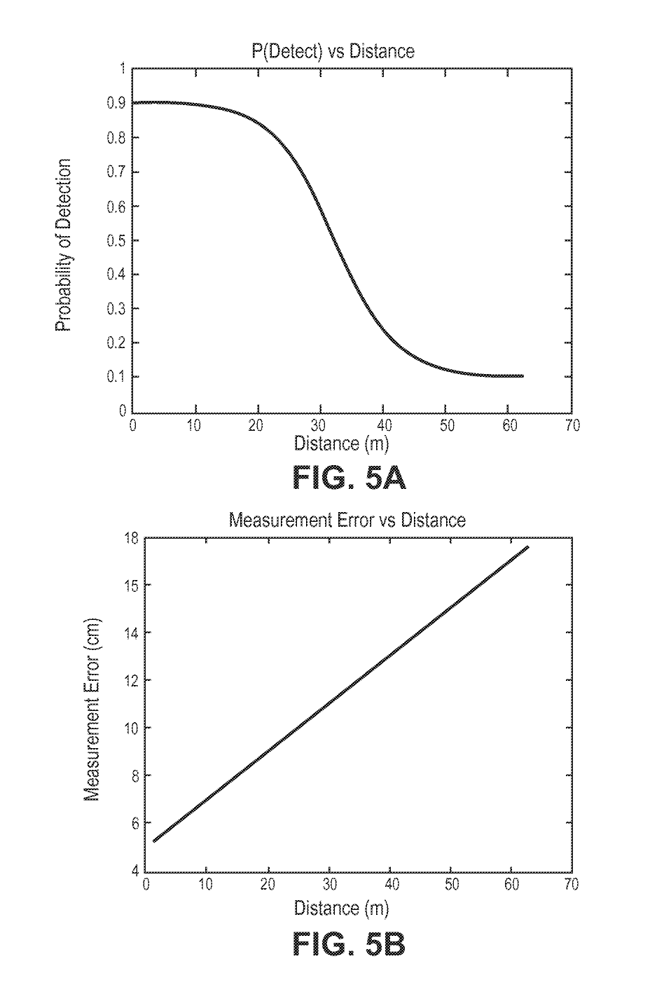

Combining computed data from Sensor Performance module 412 with constraints computed in Obstacle Sensing Requirements module 414, embodiments may then compute data comparing the performance of the sensors against the need to detect and overcome obstacles, exemplified in a Sensor Range vs. Obstacles module 418. Data computed at this module 418 may be reflected graphically, examples of which are shown in FIGS. 5A and 5B, below. Each performance of a sensor may be expressed as a function of distance to an obstacle, expressed as a probability to detect the obstacle given a distance away from the obstacle, for example. It may be seen that this module 418 begins to show more detailed performance limitations of a base platform 408 with a given set of base sensors 402, which may be important for determining an accurate, dynamic, automated performance controller.

Additionally, Sensor Locations module 416 may calculate and/or identify the location of sensors according to data supplied from base vehicle platform input 408. The location of the sensors may be reflected graphically, in a 3-dimensional space using some suitable reference frame, listed in a database, or described according to their approximate position on the base vehicle platform, e.g. at the rear, near the door, on the tread, etc. Differentiating the performance of a base sensor depending on its location on the base vehicle platform 408 may be important, for example, because a vehicle may suffer blind spots that can alter detection depending on where the sensors are.

Calculating how well the sensors detect obstacles given various locations on the base vehicle platform 408 may therefore be computed, and expressed and/or displayed in Sensor Obstacle Detection Range Matrix With Respect To (WRT) Platform module 420. The data in module 420 may be expressed in a matrix format, where each entry of the matrix represents a data set computed in the Sensor Range vs. Obstacles module 418, just for a given location of the sensor. Thus, module 420 may take as inputs the data from module 418 and applies each to sensor locations from module 416.

With knowledge of how well the sensors may detect obstacles for various locations on the base vehicle platform 408 from module 420, coupled with knowledge of the computed likelihoods of the base vehicle platform overcoming obstacles from module 422, embodiments may combine all of this data to generate System Performance Predicting Algorithm module 424. This module 424 may represent a comprehensive set of rules and constraints that expresses what elements are needed in order to achieve a certain level of system performance. Module 424 may create a system to meet the predetermined performance criteria derived from the previous modules. These determinations may be expressed as probabilities, e.g. in order to be 95% confident that collisions are avoided while traveling at 20 meters per second, obstacles must be detected at a range of 30 meters 90% accurately. The elements may include various types of data, constraints, requirements, rules, specifications, etc. describing what the system should look like in order to meet given performance criteria. Module 424 may be expressed in a multi-dimensional array or database, or may be expressed as a series of functions or surfaces as a function of multiple variables.

The preceding comprehensive rules computed in module 424 may suggest where the sensors may need to be located in order to achieve such performance, or the rules may be further limited by the locations of the sensors if the sensors cannot be moved. These added constraints may be expressed in System Performance Boundary Creation module 426. In other words, module 426 incorporates the set of rules computed in module 424 and may also include additional sensor constraints. For example, in order to achieve the above performance characteristic described for the System Performance Predicting Algorithm module 424, it may be determined that a laser sensor can be placed at the front of the base vehicle platform, but not on the sides. Alternatively, if the sensors cannot be moved, then the performance characteristics may be further constrained by what the sensor, at its fixed location, is capable of detecting. From that, it may be determined that the base vehicle platform 408 cannot travel at the desired speed, and the speed must therefore be reduced.

These types of calculations may therefore create a controller that is configured to change performance parameters for the base vehicle platform, for given environmental conditions, locations of sensors and pre-defined user inputs, without human intervention, and may be represented in Dynamically Bounded System Controller module 428. This may include dynamically changing at least one performance characteristic of the base vehicle platform, such as minimum turn radius, maximum speed, current speed, number of wheels/treads in use, etc. System controller 428 may operate in ways similar to what is described in FIGS. 3A and 3B. This controller 428 may be embodied in software, a field programmable gate array (FPGA), a state machine, any combination therein, or through other various means apparent to those with ordinary skill in the art.

In some embodiments, system controller 428 may include at least two elements: a bounded controller including a set of constraints designed to limit the performance envelope of the base vehicle platform depending on given environmental, sensor, and/or user conditions, and a lower level command controller designed to operate the base vehicle platform without human intervention, where commands are fed from the bounded controller to the command controller.

In some embodiments, the bounded controller may be responsible for generating command dynamically as environmental conditions change. For example, a base vehicle platform may be able to achieve speeds of 8 m/s and decelerate to zero in one second on dry asphalt and two seconds on wet asphalt. However, if a sensor used for detecting obstacles can reliably detect an obstacle at a distance of 4 meters on a clear day, and 3 meters on a rainy day, the maximum speed envelope must dynamically be adjusted based on the current environment to ensure that collisions do not occur. A similar example can be made with maximum turning rates as well. Due to the relationship between the rate of change in position and velocity, the bounded controller may effectively constrain the potential paths the base vehicle platform can traverse to those which are safe and controllable given the external conditions.

In some embodiments, the command controller may then be responsible for operating the base vehicle platform successfully and safely in light of the commands received from the bounded controller. For example, if 5 m/s linear velocity is commanded, the command controller may ensure appropriate torques and forces are applied such that the base vehicle platform travels 5 m/s within some small bounded error.

FIG. 4 may illustrate some embodiments utilizing the various modules being interrelated as described. However, other embodiments may not implement all of the modules, or other modules may be created apparent to those with ordinary skill in the art. For example, some embodiments may create a dynamic system controller that does not interrelate the base sensors with a base vehicle platform, but instead builds separate modules utilizing either the base sensors or the base vehicle platform only. Such modules may determine the maximum performance envelop for either the sensors or the platform, respectively, in the absence of the other input of the system. In this case, for example, it may be possible to predict maximum performance characteristics in a given environment assuming perfect sensor prediction, or the maximum range obstacles may be detected assuming an optimal performing base vehicle platform.

Referring to FIG. 5A, the graph as shown may represent an example performance plot of an output from Sensor Range vs. Obstacles module 418 in FIG. 4. Here, the independent variable is a distance of an obstacle away from the base vehicle platform, in meters. The dependent variable is the probability of detecting the obstacle at that given distance, expressed as a fraction or percentage. The graph of FIG. 5A may represent a set of actual performance characteristics of the sensor for seeing objects of different sizes. In this case, for example, FIG. 5A shows an “S” like curve, which may indicate that at close range (e.g. 0 to 20 meters), the sensors successfully detect obstacles around 90% of the time, while at long range (e.g. 50 meters and beyond), sensors detect obstacles around only 10% of the time. Module 418 may output the set of performance characteristics, including the graph of FIG. 5A, for use in the lower modules described in FIG. 4.

Similarly, FIG. 5B may represent a different example performance plot of an output from Sensor Range vs. Obstacles module 418 in FIG. 4. Here, the independent variable is a distance, in meters, while the dependent variable is an error in detecting the correct distance to the object, in centimeters. In this case, the constraints on embodiments according to this graph show a linear relationship between distance away from the base vehicle platform and measurement error, with a minimum error of about 5 centimeters allowable for obstacles within about 1 meter from the base vehicle platform, and a maximum error of about 10 centimeters allowable at a distance of 60 meters away. Some embodiments may add more information, including describing the dependent variable error measurement probabilistically (e.g. as a probability distribution based on obstacle type and as a function of the performance characteristics of the base sensors themselves). Embodiments may describe these probability distributions using various types of probability distribution functions, for example a normal distribution of potential distances measured for a given obstacle size at a given distance away from the base vehicle platform. Of course, these graphs are merely examples, and many other types of constraints are possible according to embodiments.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

Embodiments of the invention may provide for a number of advantages. These may include enabling a base vehicle platform to be operated without human intervention, using a single embodiment to dynamically control multiple base vehicle platforms, and efficiently designing a single system capable of adapting to multiple base vehicle platforms so that multiple controllers do not have to be designed to fit to multiple vehicles. Advantages may also include an easily modifiable design, in that embodiments may be comprised of multiple modules, each of which may be modified independent of other modules. Additionally, embodiments may operate the base vehicle platform safely and reliably, minimizing human injuries and structural damage to the base vehicle platform and surrounding objects. Other advantages may be readily apparent according to the disclosures herein, and embodiments are not so limited.

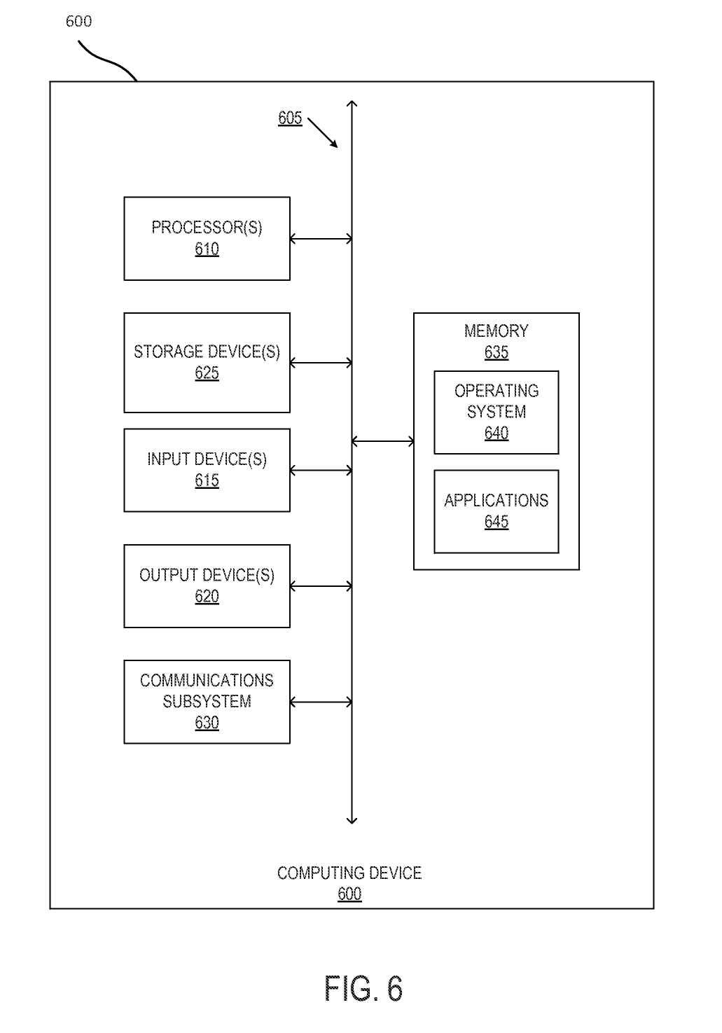

Having described multiple aspects of dynamically optimizing and automatically optimizing performance of a base vehicle platform, an example of a computing system in which various aspects of the disclosure may be implemented will now be described with respect to FIG. 6. According to one or more aspects, a computer system as illustrated in FIG. 6 may be incorporated as part of a computing device, which may implement, perform, and/or execute any and/or all of the features, methods, and/or method steps described herein. For example, computer system 600 may represent some of the components of a hand-held device. A hand-held device may be any computing device with an input sensory unit, such as a wireless receiver or modem. Examples of a hand-held device include but are not limited to video game consoles, tablets, smart phones, televisions, and mobile devices or mobile stations. In other examples, computer system 600 may represent some of the components of a system housed within a base vehicle platform. In some embodiments, the system 600 is configured to implement any of the methods described above. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, a set-top box, and/or a computer system. FIG. 6 is meant only to provide a generalized illustration of various components, any and/or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a camera, wireless receivers, wireless sensors, wired sensors, a mouse, a keyboard and/or the like; and one or more output devices 620, which can include without limitation a display unit, a printer and/or the like. In some embodiments, the one or more processor 610 may be configured to perform a subset or all of the functions described above with respect to FIGS. 3A, 3B and 4. The processor 610 may comprise a general processor and/or and application processor, for example. In some embodiments, the processor is integrated into an element that processes visual tracking device inputs and wireless sensor inputs.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 3A, 3B and 4, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein, for example methods described with respect to FIGS. 3A, 3B and 4.

The terms “machine-readable medium,” “computer-readable medium,” and “computer program product,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a non-transitory storage device 625 either before or after execution by the processor(s) 610. Memory 635 may contain at least one database according to any of the databases methods described herein. Memory 635 may thus store any of the values discussed in any of the present disclosures.

The methods described in FIGS. 3A, 3B and 4 may be implemented by various blocks in FIG. 6. For example, processor 610 may be configured to perform any of the functions of blocks in diagram 600. Storage device 625 may be configured to store an intermediate result, such as a globally unique attribute or locally unique attribute discussed within any of blocks mentioned herein. Storage device 625 may also contain a database consistent with any of the present disclosures. The memory 635 may similarly be configured to record signals, representation of signals, or database values necessary to perform any of the functions described in any of the blocks mentioned herein. Results that may need to be stored in a temporary or volatile memory, such as RAM, may also be included in memory 635, and may include any intermediate result similar to what may be stored in storage device 625. Input device 615 may be configured to receive wireless signals from satellites and/or base stations according to the present disclosures described herein. Output device 620 may be configured to display images, print text, transmit signals and/or output other data according to any of the present disclosures.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method for optimizing performance of a base vehicle platform, the method comprising:
receiving base vehicle platform data indicative of at least one performance characteristic of the base vehicle platform;
receiving environmental conditions data indicative of at least one characteristic of at least one weather condition or terrain condition;
receiving at least one user input;
receiving base sensor data from at least one base sensor indicative of at least one up-to-date environmental condition or base vehicle platform condition; and
generating at least one module based on the base vehicle platform data, the environmental conditions data, the at least one user input, and the base sensor data, such that the at least one module:
operates the base vehicle platform without human intervention, and
dynamically modifies at least one base vehicle platform performance characteristic without human reconfiguration.

2. The method of claim 1 wherein the at least one module comprises a Sensor Performance module and a Base Vehicle Platform Performance module.

3. The method of claim 2, further comprising:
generating the Sensor Performance module based on the base sensor data and the environmental conditions data, such that the Sensor Performance module determines at least one performance characteristic of the at least one base sensor for at least one environmental condition; and
generating the Base Vehicle Platform Performance module based on the base vehicle platform data and the environmental conditions data, such that the Base Vehicle Platform Performance module determines at least one optimal performance condition of the base vehicle platform as a function of at least one weather condition or terrain feature.

4. The method of claim 1 wherein the at least one module comprises a System Performance Predicting Algorithm module and a Dynamically Bounded System Controller module.

5. The method of claim 4 wherein:
the System Performance Predicting Algorithm module determines at least one constraint specifying what elements are needed in order to achieve a predetermined level of system performance of the base vehicle platform, and
the Dynamically Bounded System Controller module is configured to change at least one maximum performance characteristic of the base vehicle platform without human intervention.

6. A method for optimizing performance of a base vehicle platform, the method comprising:
receiving the base vehicle platform as an input;
generating at least one module based on the received base vehicle platform, such that the at least one module:
operates the base vehicle platform without human intervention, and
dynamically modifies a performance characteristic of the base vehicle platform without human reconfiguration.

7. The method of claim 6, further comprising:
receiving environmental conditions data as an input;
receiving user constraints data as an input;
receiving base vehicle sensor data as an input; and
wherein generating the at least one module is based further on the environmental conditions data, the user constraints data, and the base vehicle sensor data.

8. The method of claim 7, wherein the at least one module comprises an Obstacle Sensing Requirements module and a Platform vs. Obstacle Encountered module.

9. The method of claim 8, further comprising:
detecting at least one obstacle of the base vehicle platform using the obstacle Sensing Requirements module; and
calculating, using the Platform vs. Obstacle Encountered module, a likelihood metric of the base vehicle platform to determine a likelihood that the base vehicle platform will succeed against the at least one obstacle.

10. An apparatus comprising:
a receiver configured to receive:
base vehicle platform data indicative of at least one performance characteristic of a base vehicle platform;
environmental conditions data indicative of at least one characteristic of at least one weather condition or terrain condition;
at least one user input;
base sensor data from at least one base sensor indicative of at least one up-to-date environmental condition or base vehicle platform condition; and
a processor configure to generate at least one module based on the base vehicle platform data, the environmental conditions data, the at least one user input, and the base sensor data, such that the at least one module:
operates the base vehicle platform without human intervention, and
dynamically modifies at least one base vehicle platform performance characteristic without human reconfiguration.

11. The apparatus of claim 10 wherein the at least one module comprises a Sensor Performance module and a Base Vehicle Platform Performance module.

12. The apparatus of claim 11 wherein the processor is further configured to:
generate the Sensor Performance module based on the base sensor data and the environmental conditions data, such that the Sensor Performance module determines at least one performance characteristic of the at least one base sensor for at least one environmental condition; and
generate the Base Vehicle Platform Performance module based on the base vehicle platform data and the environmental conditions data, such that the Base Vehicle Platform Performance module determines at least one optimal performance condition of the base vehicle platform as a function of at least one weather condition or terrain feature.

13. The apparatus of claim 10 wherein the at least one module comprises a System Performance Predicting Algorithm module and a Dynamically Bounded System Controller module.

14. The apparatus of claim 13 wherein:
the System Performance Predicting Algorithm module determines at least one constraint specifying what elements are needed in order to achieve a predetermined level of system performance of the base vehicle platform, and
the Dynamically Bounded System Controller module is configured to change at least one maximum performance characteristic of the base vehicle platform without human intervention.

15. An apparatus comprising:
means for receiving base vehicle platform data indicative of at least one performance characteristic of a base vehicle platform;
means for receiving environmental conditions data indicative of at least one characteristic of at least one weather condition or terrain condition;
means for receiving at least one user input;
means for receiving base sensor data from at least one base sensor indicative of at least one up-to-date environmental condition or base vehicle platform condition; and
means for generating at least one module based on the base vehicle platform data, the environmental conditions data, the at least one user input, and the base sensor data, such that the at least one module:
operates the base vehicle platform without human intervention, and
dynamically modifies at least one base vehicle platform performance characteristic without human reconfiguration.

16. A computer program product residing on a processor-readable medium and comprising processor-readable instructions configured to cause a processor to:
receive base vehicle platform data indicative of at least one performance characteristic of a base vehicle platform;
receive environmental conditions data indicative of at least one characteristic of at least one weather condition or terrain condition;
receive base sensor data from at least one base sensor indicative of at least one up-to-date environmental condition or base vehicle platform condition; and
generate at least one module based on the base vehicle platform data, the environmental conditions data, and the base sensor data, such that the at least one module:
operates the base vehicle platform without human intervention, and
dynamically modifies at least one base vehicle platform performance characteristic without human reconfiguration.
